(19) United States
(12) Patent Application Publication
(10) Pub. No.: US 2020/0382299 A1
(43) Pub. Date: Dec. 3, 2020

(54) RANDOM NUMBER GENERATION SYSTEM, METHOD FOR GENERATING RANDOM NUMBER, AND RANDOM NUMBER GENERATION PROGRAM

(71) Applicant: NEC Corporation, Minato-ku, Tokyo (JP)

(72) Inventors: Yuki TANAKA, Tokyo (JP); Kazuhiko MINEMATSU, Tokyo (JP); Kentarou SASAKI, Tokyo (JP)

(73) Assignee: NEC Corporation, Minato-ku, Tokyo (JP)

(21) Appl. No.: 16/762,298

(22) PCT Filed: Nov. 8, 2017
(86) PCT No.: PCT/JP2017/040242

§ 371 Date: May 7, 2020

(51) Int. Cl. H04L 9/30; G06F 7/58

(52) U.S. Cl. CPC H04L 9/3093; H04L 9/302; G06F 7/588

(57) ABSTRACT

A random number generation system 20 generates a random number using a public key, a component of which is the member of a residue class ring modulo of a predetermined natural number excluding natural numbers represented by the power of a prime in composite numbers, the random number generation system including: a factorizing means 21 that computes the prime factorization for a predetermined natural number; and a generation means 22 that generates a random number in accordance with a discrete Gaussian distribution over a lattice wherein a vector having non-zero components of a single prime factor obtained by computing prime factorization and −1 is a basis vector.

### TECHNICAL FIELD

The present invention relates to a random number generation system, a method for generating a random number, and a random number generation program. In particular, the present invention relates to a random number generation system, a method for generating a random number, and a random number generation program used for a signature algorithm using a lattice.

### BACKGROUND ART

A trapdoor one-way function using a lattice, which is used in encryption application technology, will be described. In cryptosystems using a lattice, in particular, in many encryption application technologies such as Hash then Signature, IBE, ABE, and chosen ciphertext attack (CCA) secure encryption, a trapdoor one-way function is used.

The trapdoor one-way function is a special function in a one-way function family. An algorithm that generates the trapdoor one-way function also outputs additional information that enables computation of an inverse image of the function.

Specifically, the trapdoor one-way function is a function that is difficult to compute an inverse image (input value) satisfying a condition without additional information and is a function that enables computation of the inverse image (input value) with additional information when a one-way function and an output value of the one-way function are given. The additional information is called trapdoor. The function of the one-way function family with additional information is the trapdoor one-way function.

In a trapdoor one-way function using a lattice, a basis vector (hereinafter, also simply referred to as a basis) generated on the basis of a short vector among basis vectors constituting the lattice serves as a trapdoor. The trapdoor one-way function using a lattice is used in, for example, goldreich-goldwasser-halevi (GGH)-Proposal.

However, security of the GGH-Proposal encryption method has not been proven at the beginning. Thereafter, Nguyen and Regev have proved that GGH-Proposal is not a secure encryption method.

As described in Non Patent Literatures (NPLs) 18, 10, and, 17, various construction methods have been proposed as a construction method of an encryption application technology using the trapdoor one-way function using a lattice, even after GGH-Proposal. In particular, various encryption application technologies are constructed by using a method described in NPL 17.

Furthermore, a construction method described in NPL 10 is a construction method in which the construction method described in NPL 17 is improved by a technique called convolution described in NPL 16. Among currently known construction methods of the encryption application technology using the trapdoor one-way function using a lattice, the construction method described in NPL 10 is considered to be the best method in terms of ease of implementation and efficiency.

Note that the construction method described in NPL 10 is a method for efficiently sampling a modulus expressed by a power of a certain number. NPL 19 describes a method for efficiently sampling an arbitrary modulus. For example, encryption application technologies described in NPLs 13 to 15 are constructed on an arbitrary modulus.

The above is the description of the trapdoor one-way function using a lattice. As described above, lattice encryption is being studied as a candidate for practical encryption, encryption that provides advanced functions, and encryption that is resistant to quantum computers. Improvement of efficiency of the construction of the trapdoor one-way function using a lattice serving as a component of various encryption application technologies is one of important issues that need to be realized in order to reduce a computational load in lattice encryption.

For example, an inverse image sampling algorithm is a construction algorithm of a trapdoor one-way function that is used at a time of signature generation or ABE key generation. Hereinafter, description is given to an inverse image sampling algorithm of a trapdoor one-way function in the construction method described in NPL 10, which is considered to be the most efficient.

In order to explain the inverse image sampling algorithm described in NPL 10, a trapdoor one-way function described in NPL 10 will be described.

The trapdoor one-way function described in NPL 10 is a surjection (there is always an input value corresponding to a range). In the inverse image sampling algorithm of the trapdoor one-way function, sampling for all inverse images is performed in accordance with an appropriate distribution.

FIG. 7 is an explanatory diagram showing an example of inverse image sampling of the trapdoor one-way function described in NPL 10. Sampling is performed on an inverse image represented by a dot on a left graph shown in FIG. 7.

In the inverse image sampling algorithm, for example, sampling according to a discrete Gaussian distribution is performed. It is difficult to execute the sampling according to the discrete Gaussian distribution on an inverse image close to an origin without secret information.

The reason is that, without secret information, it becomes difficult to find a basis vector having a short length even if a lattice is given. That is, without secret information, an inverse image closer to the origin (a basis vector having a shorter length) has a smaller probability of being discovered.

Hereinafter, the discrete Gaussian distribution will be described. It is assumed that the following function is defined by a real number σ∈R (R is a symbol representing a set of all real numbers).

$$\begin{matrix}[ Formula 1 ] & \\ φ ( x ) := \frac{1}{σ} exp ( - \frac{π}{{σ}^{2}} {\vert x \vert}^{2} ) & Equation ( 1 )\end{matrix}$$

Distribution outputted with an integer value u∈Z^{N} (Z is a symbol representing a set of whole integers) with a probability φ(u)/Σ^{∞}_{j=-∞}φ(j) is called a discrete Gaussian distribution on Z^{N} in which a variance value is σ, and described as D_{Z}^{N}_{,σ}. In particular, φ(x) of σ=1 is described as ρ(x).

Hereinafter, the inverse image sampling algorithm of the trapdoor one-way function described in NPL 10 will be specifically described after description of some preparation items.

An inverse image sampling process described in NPL 10 is performed using a public key A and a trapdoor R generated in a process of generating a public key and a trapdoor. The inverse image sampling process is a process including an ON LINE phase and an OFF LINE phase.

First, symbols are organized. A lattice Λᵤ^{⊥}(A) with basis A∈Z^{n×m} is defined for A and u as follows.

[Formula 2]

Λᵤ^{⊥}(A)={\vec{z}∈Z^{m}:Az=u mod q} Equation (2)

Further, a primitive lattice matrix G is defined as follows.

$$\begin{matrix}[ Formula 3 ] & \\ G = [ \begin{matrix}\vec{g} & … & 0 \\ ⋮ & ⋱ & ⋮ \\ 0 & … & \vec{g}\end{matrix} ] ( \vec{g} = ( 1 , 2 , … , {2}^{K - 1} ) ) & Equation ( 3 )\end{matrix}$$

Under the above preparation, each of the process of generating a public key and a trapdoor and the inverse image sampling process will be specifically described.

Next, the process of generating a public key and a trapdoor will be described. The process of generating a public key and a trapdoor is a process of, with N∈Z as a security parameter, taking a parameter param=(K, N, q=2^{K}, M⁻=O(NK), M=M⁻+NK, σ=ω((log N)^{1/2}, α)) as an input, and outputting a matrix serving as a public key and a matrix serving as a trapdoor as outputs.

Note that symbols used in the text in the present description, such as “−”, “→” and “˜” should be originally written immediately above an immediately preceding character, but these are described immediately after such a character as described above due to restriction of text notation. In equations, these symbols are described in original positions.

Further, O and ω are Landau symbols. O(NK) in M⁻=O(NK) means that M⁻ is a function that can be suppressed to equal to or less than NK even in a case of N→∞. Further, α is a parameter satisfying the following conditional expression.

1/α>σ·ω(\sqrt{(log N)}) [Formula 4]

First, a procedure for generating a matrix serving as a public key will be described. The public key A is generated as follows as a matrix in which each component is Z_{q}=Z/qZ.

[Formula 5]

A=(Ā|ĀR+HG) Equation (4)

That is, a component of the public key A corresponds to a member of a residue class ring modulo of q. Therefore, q corresponds to the modulus.

Note that, as in Equation (4), the notation (E|F) for the matrices E and F means that the matrices E and F are arranged side by side. Further, A⁻ in Equation (4) is a matrix uniformly sampled from Z_{q}^{N×M-}. That is, A⁻ is an N-row M⁻-column matrix in which each component is Z_{q}.

Further, H in Equation (4) is a regular matrix of Z_{q}^{N×N}. That is, H is an N-row N-column regular matrix in which each component is Z_{q}.

Further, R∈Z^{M-×NK} in Equation (4) is a matrix in which each column vector is generated from a discrete Gaussian distribution on Z^{M-} whose variance value is σ.

Hereinafter, an inverse image sampling process executed in accordance with the inverse image sampling algorithm will be described. Inputs to the inverse image sampling process are the public key A, the trapdoor R, the regular matrix H, a vector u^{→}, and a variance value s. Further, outputs of the inverse image sampling process include a random number in accordance with a discrete Gaussian distribution with a variance value s over the lattice of Equation (2). Note that the variance value s in this process is expressed as follows.

$$s = \sqrt{\frac{2 n log q}{π}} ω ( \sqrt{log n} ) \qquad [ Formula 6 ]$$

FIG. 8 is an explanatory diagram showing an example of the inverse image sampling process described in NPL 10. Hereinafter, the inverse image sampling process will be described with reference to FIG. 8.

### [OFF LINE Step 1]

In OFF LINE step 1, a perturbation vector is generated as follows.

$$\begin{matrix}1. \vec{p} ← {D}_{z , \sqrt{2} \cdot ω ( \sqrt{log n} )}^{n log q} & [ Formula 7 ] \\ 2. [ \begin{matrix}- R \\ I\end{matrix} ] \vec{p} & \end{matrix}$$

A vector generated as described above is newly determined as p^{→}. p^{→} shown in FIG. 8 is a perturbation vector.

### [OFF LINE Step 2]

In OFF LINE step 2, Ap^{→} is computed. The vector Ap^{→} shown in FIG. 8 may be a long vector.

### [ON LINE Step 1]

In ON LINE step 1, when a vector v^{→} is given, the vector u^{→} is generated as follows.

$$\begin{matrix}1. {\vec{v}}^{′} ← \vec{v} - A \vec{p} & [ Formula 8 ] \\ 2. \vec{s} ← {D}_{{Λ}_{{\vec{v}}^{′}}^{⊥} ( G )} & \\ 3. \vec{u} ← [ \begin{matrix}- R \\ I\end{matrix} ] \vec{s} & \end{matrix}$$

Note that, as shown in FIG. 8, among vectors that become v^{→}−Ap^{→} when A is applied, a short vector is sampled as u^{→}.

### [ON LINE Step 2]

Finally, p^{→}+u^{→} is computed and outputted in ON LINE step 2. A vector “output” shown in FIG. 8 is the computed vector.

### CITATION LIST

### Non Patent Literature

NPL 1: Richard Lindner and Chris Peikert, “Better Key Sizes (and Attacks) for LWE-Based Encryption”, In CT-RSA, Springer, 2011, volume 6558 of Lecture Notes in Computer Science, pages 319-339.

NPL 2: Leo Ducas, Alain Durmus, Tancrede Lepoint, and Vadim Lyubashevsky, “Lattice Signatures and Bimodal Gaussians”, IACR Cryptology ePrint Archive, 2013, pages 383-423.

NPL 3: Erdem Alkim, Leo Ducas, Thomas Poppelmann, and Peter Schwabe, “Post-quantum key exchange—a new hope”, IACR Cryptology ePrint Archive, 2016, pages 1092-1113.

NPL 4: Zvika Brakerski, Craig Gentry, and Vinod Vaikuntanathan, “Fully Homomorphic Encryption without Bootstrapping”, ITCS '12 Proceedings of the 3rd Innovations in Theoretical Computer Science Conference, pages 309-325.

NPL 5: Zvika Brakerski and Vinod Vaikuntanathan, “Efficient Fully Homomorphic Encryption from (Standard) LWE”, In IEEE 52nd Annual Symposium on Foundations of Computer Science, FOCS 2011, Palm Springs, Calif., USA, Oct. 22-25, 2011, pages 97-134.

NPL 6: Zvika Brakerski and Vinod Vaikuntanathan, “Fully Homomorphic Encryption from Ring-LWE and Security for Key Dependent Messages”, In CRYPTO, Springer, 2011, volume 6841 of Lecture Notes in Computer Science, pages 505-524.

NPL 7: Craig Gentry, “Fully Homomorphic Encryption Using Ideal Lattices”, In STOC, ACM, 2009, pages 169-178.

NPL 8: Craig Gentry and Shai Halevi, “Fully Homomorphic Encryption without Squashing Using Depth-3 Arithmetic Circuits”, IACR Cryptology ePrint Archive, 2011, pages 279-299.

NPL 9: David Cash, Dennis Hofheinz, Eike Kiltz, and Chris Peikert, “Bonsai Trees, or How to Delegate a Lattice Basis”, IACR Cryptology ePrint Archive, 2010, pages 591-626.

NPL 10: Daniele Micciancio and Chris Peikert, “Trapdoors for Lattices: Simpler, Tighter, Faster, Smaller”, In EUROCRYPT, Springer, 2012, volume 7237 of Lecture Notes in Computer Science, pages 700-740.

NPL 11: Sergey Gorbunov, Vinod Vaikuntanathan, and Hoeteck Wee, “Attribute-Based Encryption for Circuits”, J. ACM, 2015, 62(6), 45:1-45:34.

NPL 12: Peter W. Shor, “Polynomial-Time Algorithms for Prime Factorization and Discrete Logarithms on a Quantum Computer”, SIAM Review, 1999, 41(2), 303-332.

NPL 13: Vadim Lyubashevsky, Daniele Micciancio, Chris Peikert, and Alon Rosen, “SWIFFT: A Modest Proposal for FFT Hashing”, In Fast Software Encryption, 15th International Workshop, FSE 2008, Lausanne, Switzerland, Feb. 10-13, 2008, Revised Selected Papers, pages 54-69.

NPL 14: Craig Gentry, Shai Halevi, Chris Peikert, and Nigel P. Smart, “Field Switching in BGV-Style Homomorphic Encryption”, Journal of Computer Security, 2013, 21(5), pages 663-680.

NPL 15: Zvika Brakerski, Vinod Vaikuntanathan, Hoeteck Wee, and Daniel Wichs, “Obfuscating Conjunctions under Entropic Ring LWE”, In Proceedings of the 2016 ACM Conference on Innovations in Theoretical Computer Science, Cambridge, Mass., USA, Jan. 14-16, 2016, pages 147-163.

NPL 16: Chris Peikert, “An Efficient and Parallel Gaussian Sampler for Lattices”, Advances in Cryptology—CRYPTO 2010, pages 80-98.

NPL 17: Craig Gentry, Chris Peikert, and Vinod Vaikuntanathan, “Trapdoors for Hard Lattices and New Cryptographic Constructions”, STOC, 2008, pages 197-234.

NPL 18: Miklos Ajtai, “Generating Hard Instances of the Short Basis Problem”, ICALP, 1999, pages 1-9.

NPL 19: Daniele Micciancio and Nicholas Genise, “Faster Gaussian Sampling for Trapdoor Lattices with Arbitrary Modulus”, IACR Cryptology ePrint Archive, 2017, pages 308-328.

### SUMMARY OF INVENTION

### Technical Problem

In the inverse image sampling process described above, the ON LINE phase is a phase that directly affects efficiency of construction of the encryption application technology. Hereinafter, algorithm efficiency in the ON LINE phase will be considered.

An optimal algorithm for the ON LINE phase is classified depending on whether or not a modulus q when the method described in NPL 10 is executed is represented by a power of a certain number. When the modulus q is represented by a power of a certain number, the optimal algorithm for the ON LINE phase is the algorithm described in NPL 10.

However, NPL 10 does not describe an optimal algorithm for an arbitrary modulus that is not necessarily represented by a power of a certain number. In order to construct encryption application technologies described in NPLs 13 to 15 above, an algorithm for an arbitrary modulus is required.

As described above, NPL19 describes a method for efficiently sampling an arbitrary modulus. However, a method described in NPL 19 has the following implementation problem.

A one-dimensional discrete Gaussian distribution is called multiple times in “2. s^{→}←D_{Λ}^{⊥}_{v′→}(G)” of ON LINE step 1 of the ON LINE phase. That is, a computation speed of ON LINE phase processing depends on the number of calls of the one-dimensional discrete Gaussian distribution and a type of the discrete Gaussian distribution. A discrete Gaussian distribution whose center and variance value are parameters is classified into a stable distribution and a dynamic distribution.

When the stable distribution is called, a random number can be generated by a Look-up-table method (also called a cumulative method) described in NPL 16. When random numbers are generated by the look-up-table method, the number of operations is reduced, and the computation speed of the inverse image sampling process becomes relatively high.

When the dynamic distribution is called, a random number cannot be generated by the cumulative method because a center fluctuates. Therefore, when the dynamic distribution is called, a random number is generated by a generation algorithm having a relatively low computation speed due to a large number of operations, such as a rejection sampling method described in NPL 17.

As described above, the optimal algorithm in the processing of 2. of ON LINE step 1 depends on the modulus q of the lattice. Specifically, the optimal algorithms are classified into two types respectively corresponding to two patterns of:
(1). a pattern in which the modulus q is expressed as a power of a prime, and
(2). a pattern in which modulus q is other than (1).

Further, the optimal algorithm corresponding to the pattern (2) is described in NPL 19 as described above. In the algorithm described in NPL 19, all different discrete Gaussian distributions are called K times in the processing of 2. of ON LINE step 1.

That is, at the time of ON LINE processing, calls of K pieces of all dynamic discrete Gaussian distributions are required. A computation speed of the above processing is lower than a computation speed of processing in which a call of a static discrete Gaussian distribution is required K times in the optimal algorithm corresponding to the pattern of (1).

### Object of Invention

Therefore, an object of the present invention is to provide a random number generation system, a method for generating a random number, and a random number generation program that can increase a computation speed of an inverse image sampling process executed on an arbitrary modulus, to solve the above-described problem.

### Solution to Problem

The random number generation system according to the present invention is a random number generation system for generating a random number using a public key, a component of which is the member of a residue class ring modulo of a predetermined natural number excluding natural numbers represented by the power of a prime in composite numbers. The random number generation system includes: a factorizing means which computes the prime factorization for a predetermined natural number; and a generation means which generates a random number in accordance with a discrete Gaussian distribution over a lattice wherein a vector having non-zero components of a single prime factor obtained by computing prime factorization and −1 is a basis vector.

A method for generating a random number according to the present invention is a method for generating a random number executed in a random number generation system for generating a random number using a public key, a component of which is the member of a residue class ring modulo of a predetermined natural number excluding natural numbers represented by the power of a prime in composite numbers. The method for generating a random number computes the prime factorization for a predetermined natural number; and generates a random number in accordance with a discrete Gaussian distribution over a lattice wherein a vector having non-zero components of a single prime factor obtained by computing prime factorization and −1 is a basis vector.

A random number generation program according to the present invention causes a computer to execute: a factorizing process of computing the prime factorization for a predetermined natural number in a random number generated with use of a public key, a component of which is the member of a residue class ring modulo of a predetermined natural number excluding natural numbers represented by the power of a prime in composite numbers; and a generation process of generating a random number in accordance with a discrete Gaussian distribution over a lattice wherein a vector having non-zero components of a single prime factor obtained by computing prime factorization and −1 is a basis vector.

### Advantageous Effects of Invention

According to the present invention, a computation speed of an inverse image sampling process executed on an arbitrary modulus can be increased.

### BRIEF DESCRIPTION OF DRAWINGS

FIG. 1 is an explanatory diagram showing an example of a random number generation algorithm according to a discrete Gaussian distribution when a modulus q is represented by a power of a prime.

FIG. 2 is a block diagram showing a configuration example of a first exemplary embodiment of an inverse image sampling system according to the present invention.

FIG. 3 is a block diagram showing a configuration example of a lattice factor generation device 100 according to the first exemplary embodiment.

FIG. 4 is a block diagram showing a configuration example of a lattice factor sampling means 210₁ of the first exemplary embodiment.

FIG. 5 is a flowchart showing an operation of an inverse image sampling process by an inverse image sampling system 10 of the first exemplary embodiment.

FIG. 6 is a block diagram showing an outline of a random number generation system according to the present invention.

FIG. 7 is an explanatory diagram showing an example of inverse image sampling of a trapdoor one-way function described in NPL 10.

FIG. 8 is an explanatory diagram showing an example of an inverse image sampling process described in NPL 10.

### DESCRIPTION OF EMBODIMENTS

The present invention provides a procedure for designing a primitive lattice basis suitable for inverse image computation. When the primitive lattice basis is designed by the procedure according to the present invention, the inverse image computation can be executed in parallel. Further, it becomes possible to execute the inverse image computation without executing a random number generation process in which a dynamic discrete Gaussian distribution is called, which is slower than a random number generation process in which a static discrete Gaussian distribution is called.

First, a process of “2. s^{→}←D_{Λ}^{⊥}_{v′→}(G)” of ON LINE step 1, which is a target part of the issue, will be briefly described. The procedure of 2. of ON LINE step 1 is a procedure for generating a random number in accordance with a discrete Gaussian distribution whose origin is a center over a next lattice when v′^{→}=(v₁, . . . , vₙ).

$$\begin{matrix}[ Formula 9 ] & \\ \underbrace{( {v}_{1} , 0 , … , 0 )}_{K pieces of component} + Λ ( S ) ⊕ \underbrace{( {v}_{2} , 0 , … , 0 )}_{K pieces of component} + Λ ( S ) ⊕ … ⊕ \underbrace{( {v}_{n} , 0 , … , 0 )}_{K pieces of component} + Λ ( S ) & Equation ( 5 )\end{matrix}$$

S in Equation (5) is also called a dual primitive lattice matrix of a primitive lattice matrix G. A basis matrix of the dual primitive lattice matrix S is expressed as follows when the modulus q is q=2^{K}.

$$S = [ \begin{matrix}2 & 0 & … & & 0 \\ - 1 & 2 & 0 & … & 0 \\ 0 & - 1 & 2 & & 0 \\ & & & ⋱ & ⋮ \\ & & & - 1 & 2\end{matrix} ] \qquad [ Formula 10 ]$$

Further, when the modulus q is an arbitrary value and is expressed as q=q₀·1+q₁·2+ . . . +qₖ₋₁·2^{k-1} (where qᵢ∈{0,1}), a basis matrix of the dual primitive lattice S is represented as follows.

$$S = [ \begin{matrix}2 & 0 & … & & {q}_{0} \\ - 1 & 2 & 0 & … & {q}_{1} \\ 0 & - 1 & 2 & & {q}_{2} \\ & & & ⋱ & ⋮ \\ & & & - 1 & {q}_{k - 1}\end{matrix} ] \qquad [ Formula 11 ]$$

A lattice Λ(S) for the matrix S=[s₁^{→}, . . . , s_{K}^{→}] in Equation (5) is a lattice having s₁^{→}, . . . , s_{K}^{→} as a basis.

In 2. of ON LINE step 1, the following random numbers (1) to (n) are generated in parallel.

(1) Random numbers (x₀¹, . . . , x_{K-1}¹) according to a discrete Gaussian distribution whose origin is a center on (v₁,0, . . . , 0)+Λ(S);

(2) Random numbers (x₀², . . . , x_{K-1}²) according to a discrete Gaussian distribution whose origin is a center on (v₂,0, . . . , 0)+Λ(S);

(n) Random numbers (x₀ⁿ, . . . , x_{K-1}ⁿ) according to a discrete Gaussian distribution whose origin is a center on (vₙ,0, . . . , 0)+Λ(S).

Finally, (x₀¹, . . . , x_{K-1}¹, x₀², . . . , x_{K-1}², . . . , x₀ⁿ, . . . , x_{K-1}ⁿ) are outputted as generated random numbers. In the present exemplary embodiment, the method described in NPL 17 is used as a method for generating a random number in accordance with a discrete Gaussian distribution whose origin is a center over each lattice described above.

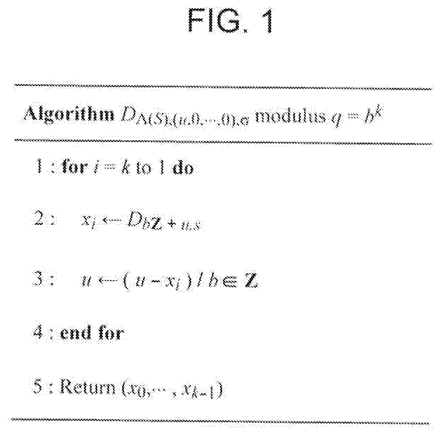

When the modulus q is represented by a power of a prime as in q=2^{K} described above, a basis matrix of the dual primitive lattice S becomes a simple matrix, and a random number is generated in accordance with the algorithm shown in FIG. 1. FIG. 1 is an explanatory diagram showing an example of a random number generation algorithm according to a discrete Gaussian distribution when the modulus q is represented by a power of a prime.

In step 2. of the algorithm shown in FIG. 1, a random number xᵢ according to a discrete Gaussian distribution is generated. Then, in step 3., a center u is updated. The processing of steps 2. and 3. above is repeated k times. Finally, after the random number generated in step 5. is outputted, the algorithm is ended.

Note that D_{bZ+u,s} in step 2. shown in FIG. 1 is a probability distribution generated on the basis of bx+u, which is a value obtained by multiplying, by b, a random number x generated from a discrete Gaussian distribution on an integer whose center is u/b and variance value is s/b, and adding u. That is, D_{bZ+u,s} is a probability distribution whose output value is on (bZ+u) and whose function that defines the distribution is proportional to exp(−x²/s²).

In step 2. shown in FIG. 1, a dynamic discrete Gaussian distribution is not called. That is, a plurality of static discrete Gaussian distributions with at most b types of centers are used, to generate a random number in accordance with a discrete Gaussian distribution whose center on (vᵢ,0, . . . , 0)+Λ(S) (i=1 to n) is not necessarily an origin.

A reason why the static discrete Gaussian distribution can be used is because preparation as a static discrete Gaussian distribution in advance becomes a practically executable process since the discrete Gaussian distribution has at most b types of centers.

Further, the reason why b pieces of discrete Gaussian distributions need to be prepared is because, if discrete Gaussian distributions whose center is non-integer values 0/b, 1/b, 2/b, . . . , (b−1)/b are individually prepared, the distribution translates when an appropriate integer value is added, and therefore a discrete Gaussian distribution whose center is u/b (u is an integer) is generated.

However, when the modulus q, which is a composite number, corresponds to the pattern of (2), that is, when it is not represented by a power of a prime, a method using the algorithm described in NPL 17 as it is, or a method described in NPL 19 is used to generate a random number in accordance with a discrete Gaussian distribution. That is, the dynamic discrete Gaussian distribution is called K times repeatedly.

In the present exemplary embodiment, inverse image sampling is executed in parallel by newly designing a dual primitive lattice S even when the modulus q, which is a composite number, corresponds to the pattern of (2). In addition, each parallel computation is executed with use of a method for generating a random number in accordance with a discrete Gaussian distribution with a relatively high computation speed. Further, since the number of columns of a matrix of a public key is reduced, a public key length is further reduced.

Hereinafter, a method of generating a random number in accordance with a discrete Gaussian distribution of the present exemplary embodiment will be described. When the modulus q, which is a composite number, corresponds to the pattern of (2), the modulus q is considered to be the following composite number.

[Formula 12]

q=p₁^{r}^{₁} . . . pₗ^{r}^{ₗ} Equation (6)

The following vector g^{˜} is defined for the modulus q expressed as described above.

[Formula 13]

\tilde{g}:=(f₁p₁·f₁ . . . p₁^{r}^{₁}⁻¹·f₁,f₂p₂·f₂ . . . p₂^{r}^{₂}⁻¹·f₂, . . . ,fₗpₗ·fₗ . . . pₗ^{r}^{ₗ}⁻¹·fₗ)

Note that, for example, f₁ and p₁·f₁ . . . p₁^{r1-1}·f₁ in the vector g^{˜} are simply arranged side by side in one line. By using the above vector g^{˜}, the following primitive lattice matrix G^{˜} is defined.

$$\tilde{G} = [ \begin{matrix}\tilde{g} & 0 & … & & 0 \\ 0 & \tilde{g} & 0 & … & 0 \\ & & ⋱ & & \\ & & & & \tilde{g}\end{matrix} ] \qquad [ Formula 14 ]$$

In a case where the above primitive lattice matrix G^{˜} and the primitive lattice matrix G are replaced, when v′^{→}=(v₁, . . . , vₙ), the procedure of 2. of ON LINE step 1 is converted to a procedure for generating a random number in accordance with a discrete Gaussian distribution whose origin is a center over a next lattice instead of the lattice shown in Equation (5).

[Formula 15]

(α₁¹,0, . . . ,0,α₁²,0, . . . ,α₁¹,0, . . . ,0)+Λ(S)⊕ . . . ⊕(αₙ¹,0, . . .,0,αₙ²,0, . . . ,αₙ¹,0, . . . ,0)+Λ(S) Equation (7)

Note that, α₁¹, . . . , α₁¹, . . . , αhd n¹, . . . , αₙ¹ shown in Equation (7) are coefficients defined as follows. First, a₁ . . . a₁ satisfying a₁·f₁+ . . . +a₁·f₁=1 are obtained. Next, the following equations are generated.

(a₁·v₁)·f₁+ . . . +(a₁·v₁)·f₁=v₁

(a₁·v₂)·f₁+ . . . +(a₁·v₂)·f₁=v₂

(a₁·v₃)·f₁+ . . . +(a₁·v₃)·f₁=v₃

. . .

(a₁·vₙ)·f₁+ . . . +(a₁·vₙ)·f₁=vₙ

For example, (a₁·v₁) in the above equation becomes α₁¹. On the basis of the above equations, αᵢ^{j} (i=1 to l, j=1 to n) is generated.

Further, when the primitive lattice matrix G^{˜} and the primitive lattice matrix G are replaced, the dual primitive lattice S is designed as follows.

$$S = [ \begin{matrix}{p}_{1} & 0 & 0 & 0 & & & & & & & & & \\ - 1 & {p}_{1} & 0 & 0 & & & & & & & & & \\ & - 1 & {p}_{1} & 0 & & & & & & & & & \\ & & ⋱ & & & & & & & & & & \\ 0 & … & & {p}_{1} & & & & & & & & & \\ 0 & … & & 0 & {p}_{2} & 0 & 0 & 0 & & & & & \\ 0 & … & & 0 & - 1 & {p}_{2} & 0 & 0 & & & & & \\ 0 & … & & 0 & & ⋱ & & & & & & & \\ 0 & … & & 0 & & & & {p}_{2} & & & & & \\ & & & & & & & & ⋱ & & & & \\ 0 & & & & & … & & 0 & & {p}_{l} & 0 & 0 & 0 \\ 0 & & & & & … & & 0 & & - 1 & {p}_{l} & 0 & 0 \\ 0 & & & & & … & & 0 & & & ⋱ & & \\ 0 & & & & & … & & 0 & & & & & {p}_{l}\end{matrix} ] \qquad [ Formual 16 ]$$

On the basis of the above dual primitive lattice S, for example, a matrix S₁, a matrix S₂, and a matrix Sₗ are respectively defined as follows.

$$\begin{matrix}{S}_{1} = [ \begin{matrix}{p}_{1} & 0 & 0 & 0 \\ - 1 & {p}_{1} & 0 & 0 \\ & - 1 & {p}_{1} & 0 \\ & & ⋱ & \\ 0 & … & & {p}_{1}\end{matrix} ] {S}_{2} = [ \begin{matrix}{p}_{2} & 0 & 0 & 0 \\ - 1 & {p}_{2} & 0 & 0 \\ & - 1 & {p}_{2} & 0 \\ & & ⋱ & \\ 0 & … & & {p}_{2}\end{matrix} ] & [ Formula 17 ] \\ {S}_{l} = [ \begin{matrix}{p}_{l} & 0 & 0 & 0 \\ - 1 & {p}_{l} & 0 & 0 \\ & - 1 & {p}_{l} & 0 \\ & & ⋱ & \\ 0 & … & & {p}_{l}\end{matrix} ] & \end{matrix}$$

When a lattice with the matrix S₁ as a basis matrix is Λ(S₁), a lattice with the matrix S₂ as a basis matrix is Λ(S₂), . . . , and a lattice with the matrix Sₗ as a basis matrix is Λ(Sₗ), the following relationship is satisfied.

Λ(S)=Λ(S₁)⊕ . . . ⊕Λ(Sₗ) [Formula 18]

Therefore, a process of generating a random number in accordance with a discrete Gaussian distribution over (vᵢ,0, . . . , 0)+Λ(S) is divided into each process for generating a random number in accordance with a discrete Gaussian distribution over each lattice of Λ(S₁), . . . , Λ(Sₗ). Each of the divided generation processes can be executed in parallel.

Furthermore, since the modulus q of each lattice of Λ(S₁), . . . , Λ(Sₗ) corresponds to the pattern of (1), a random number in accordance with a discrete Gaussian distribution over each lattice can be generated without using a dynamic discrete Gaussian distribution.

Further, a horizontal length of the primitive lattice matrix G is changed from log₂ q to (r₁+ . . . +rₗ). Since a relationship of “log₂ q>(r₁+ . . . +rₗ)” is satisfied, the horizontal length of the primitive lattice matrix G is reduced.

Regarding a reason why the above relationship is satisfied, log₂ q is computed as follows from Equation (6).

log₂ q=r₁·log₂ p₁+ . . . +rₗ·log₂ p₁

Therefore, since prime factors p₁, p₂, . . . , pₗ are all 2 or more, the relationship of “log₂ q>(r₁+ . . . +rₗ)” is satisfied.

Further, the public key A is expressed as in Equation (4). Since the public key A includes the primitive lattice matrix G, a public key length is also reduced in the present exemplary embodiment.

### Description of Configuration

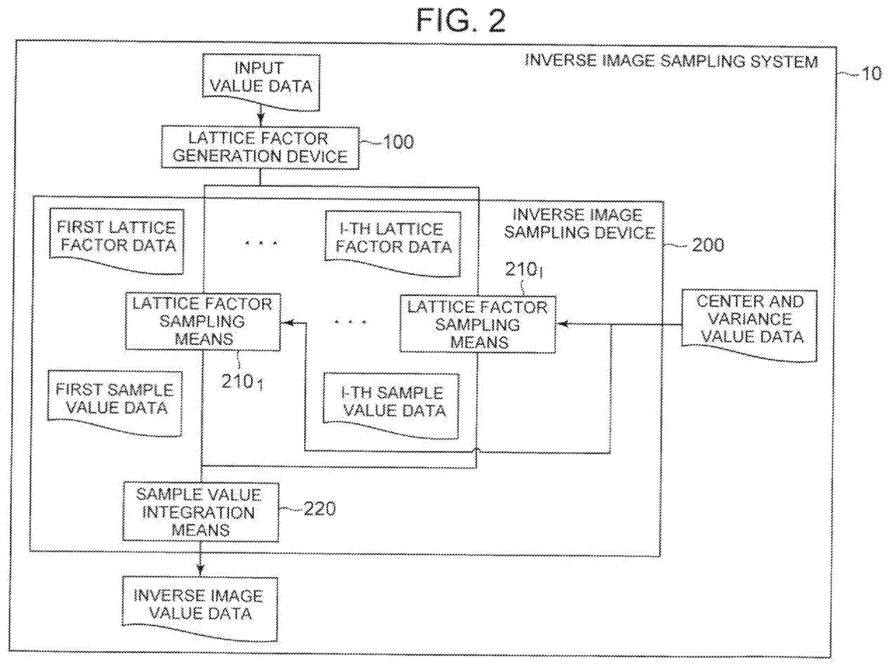

FIG. 2 is a block diagram showing a configuration example of the first exemplary embodiment of an inverse image sampling system according to the present invention. As shown in FIG. 2, an inverse image sampling system 10 of the present exemplary embodiment includes a lattice factor generation device 100 and an inverse image sampling device 200.

The inverse image sampling system 10 of the present exemplary embodiment generates a random number using a public key, a component of which is the member of a residue class ring modulo of a predetermined natural number excluding natural numbers represented by the power of a prime in composite numbers. That is, the inverse image sampling system 10 can execute the inverse image sampling process at a higher speed on the modulus that is a composite number corresponding to the pattern (2).

The inverse image sampling system 10 of the present exemplary embodiment is a system related to a public key of a trapdoor one-way function and an inverse image computation process algorithm, which are basic elements of an encryption application technology. Specifically, the inverse image sampling system 10 can design a trapdoor one-way function so as to increase parallelism of inverse image computation as compared to an inverse image computation process of a trapdoor one-way function designed by a general method.

In addition, the inverse image sampling system 10 can further shorten a public key length. Each inverse image computation of the trapdoor one-way function designed by the inverse image sampling system 10 is also efficiently executed.

As shown in FIG. 2, the inverse image sampling device 200 includes lattice factor sampling means 210₁ to 210ₗ and a sample value integration means 220. To the lattice factor sampling means 210₁ to 210ₗ, first lattice factor data, . . . , l-th lattice factor data are respectively inputted from the lattice factor generation device 100. Further, data indicating a center and a variance value are inputted to the lattice factor sampling means 210₁ to 210ₗ.

Further, as shown in FIG. 2, first sample value data, . . . , l-th sample value data respectively outputted from the lattice factor sampling means 210₁ to 210ₗ are inputted to the sample value integration means 220. The sample value integration means 220 generates inverse image value data by integrating the inputted sample value data.

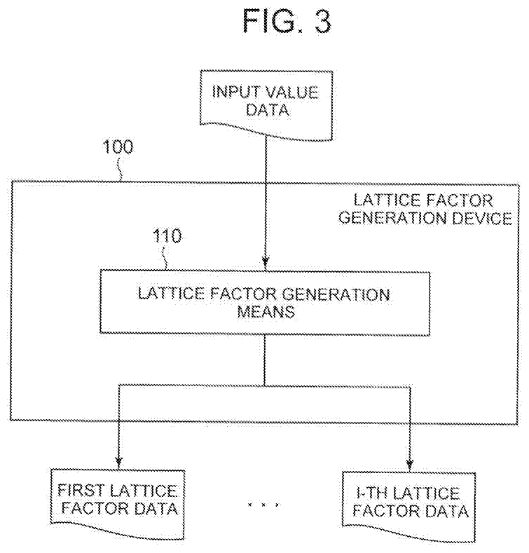

FIG. 3 is a block diagram showing a configuration example of the lattice factor generation device 100 according to the first exemplary embodiment. As shown in FIG. 3, the lattice factor generation device 100 of the present exemplary embodiment includes a lattice factor generation means 110.

The lattice factor generation device 100 receives a modulus q as input value data. The lattice factor generation means 110 computes prime factorization on the received modulus q. For example, the lattice factor generation means 110 factorizes the modulus q into p₁^{r1}, . . . , pₗ^{r1}.

After computing the prime factorization, the lattice factor generation means 110 generates fᵢ, pᵢ, and rᵢ as i-th lattice factor data. fᵢ is data represented as follows.

fᵢ=p₁^{r}^{₁} . . . pᵢ₋₁^{r}^{_{i−1}}·pᵢ₊₁^{r}^{ᵢ₊₁} . . . pₗ^{r}^{ₗ} [Formula 19]

fᵢ is a value obtained by multiplying all of p₁^{r1}, pᵢ₋₁^{ri-1}, pᵢ₊₁^{ri+1}, and pₗ^{r1}. For example, f₁ and f₂ are respectively represented as follows.

f₁=p₂^{r2} . . . p₁^{r1},f₂=p₁^{r1}·p₃^{r3} . . . pₗ^{r1}

That is, the lattice factor generation means 110 outputs the i-th lattice factor data as “i-th lattice factor data=(fᵢ, pᵢ, rᵢ)”. With the above method, the lattice factor generation means 110 generates and outputs the first to l-th lattice factor data individually.

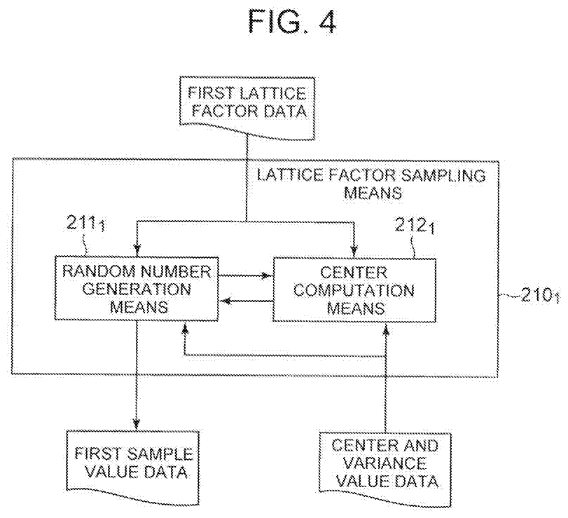

FIG. 4 is a block diagram showing a configuration example of the lattice factor sampling means 210₁ of the first exemplary embodiment. Each of the lattice factor sampling means 210₁ to 210ₗ performs an inverse image sampling process by using a primitive lattice proposed in the present exemplary embodiment.

As shown in FIG. 4, the lattice factor sampling means 210₁ of the present exemplary embodiment has a random number generation means 211₁ and a center computation means 212₁. Note that each configuration of the lattice factor sampling means 210₂ to 210₁ is similar to the configuration of the lattice factor sampling means 210₁ shown in FIG. 4.

As shown in FIG. 4, the lattice factor sampling means 210₁ receives, as an input, the first lattice factor data and data indicating a center and a variance value.

The lattice factor sampling means 210₁ generates a random number over a lattice in accordance with a sampling algorithm shown in FIG. 1. Specifically, the lattice factor sampling means 210₁ individually substitutes p₁ for b and r₁ for k in the algorithm shown in FIG. 1.

Further, the lattice factor sampling means 210₁ sets u=α₁ⁱ in i-th loop computation according to the algorithm shown in FIG. 1.

The random number generation means 211₁ executes step 2. and generates a random number xᵢ according to a one-dimensional discrete Gaussian distribution. Further, the center computation means 212₁ executes step 3. and updates the center u. Finally, the random number generation means 211₁ outputs a set of generated random numbers as the first sample value data.

The lattice factor sampling means 210₁ generates a random number in accordance with a discrete Gaussian distribution over a lattice whose modulus is represented by a power of a prime. Specifically, the lattice factor sampling means 210₁ generates a random number in accordance with a discrete Gaussian distribution over a lattice wherein a vector having non-zero components of a single prime factor p₁ obtained by computing prime factorization and −1 is a basis vector. Therefore, when a random number is generated by a cumulative method, the random number generation means 211₁ can generate k pieces of random number at a time.

The sample value integration means 220 generates inverse image value data by arranging individual values indicated by the first to l-th sample value data side by side. The sample value integration means 220 outputs the generated inverse image value data.

### Description of Operation

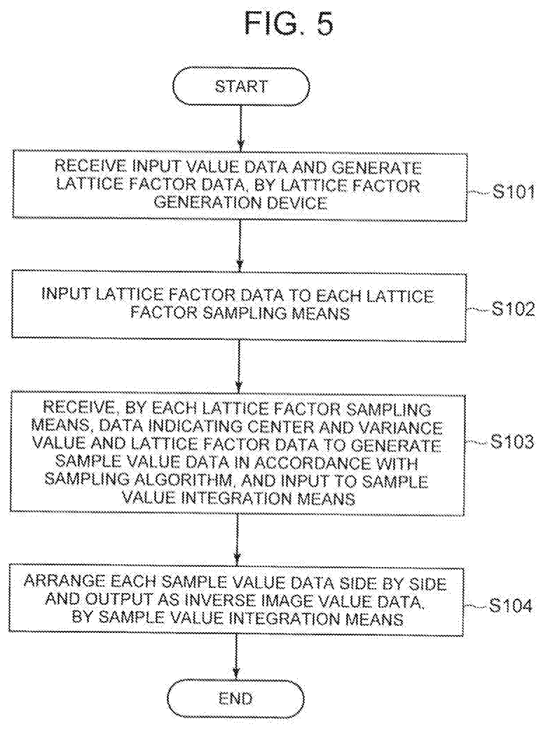

Hereinafter, an operation in which the inverse image sampling system 10 of the present exemplary embodiment executes inverse image sampling will be described with reference to FIG. 5. FIG. 5 is a flowchart showing an operation of an inverse image sampling process by the inverse image sampling system 10 of the first exemplary embodiment.

First, the lattice factor generation device 100 receives the modulus q as input value data. The lattice factor generation means 110 of the lattice factor generation device 100 generates first to l-th lattice factor data individually on the basis of the received modulus q (step S101).

Next, the lattice factor generation device 100 inputs the generated first to l-th lattice factor data to the lattice factor sampling means 210₁ to 210ₗ, respectively (step S102).

Each of the lattice factor sampling means 210₁ to 210ₗ individually receives, as inputs, data indicating a center and a variance value, and lattice factor data. Next, each of the lattice factor sampling means 210₁ to 210₁ individually generates a random number over a lattice in accordance with the sampling algorithm shown in FIG. 1 on the basis of the received data.

Finally, the lattice factor sampling means 210₁ to 210ₗ each generate a set of generated random numbers as first to l-th sample value data, respectively. The lattice factor sampling means 210₁ to 210ₗ each inputs the generated first to l-th sample value data respectively, to the sample value integration means 220 (step S103).

Next, the sample value integration means 220 generates inverse image value data by arranging individual values indicated by the inputted first to l-th sample value data side by side. Next, the sample value integration means 220 outputs the generated inverse image value data (step S104). After outputting the inverse image value data, the inverse image sampling system 10 ends the inverse image sampling process.

### Description of Effect

The inverse image sampling system 10 of the present exemplary embodiment changes a design method of a primitive lattice matrix (primitive lattice) when the modulus q of a lattice not expressed by a power of a prime is a composite number composed of powers of different small primes. Specifically, the lattice factor generation device 100 of the inverse image sampling system 10 virtually divides the primitive lattice matrix into a plurality of matrices each having a modulus represented by a power of a prime.

In addition, the inverse image sampling device 200 of the inverse image sampling system 10 virtually separates the inverse image sampling algorithm into a plurality of sampling algorithms that generate a random number over each lattice having each divided matrix as a basis matrix. Each of the virtually separated algorithms can be executed in parallel.

With the above configuration, the inverse image sampling system 10 of the present exemplary embodiment can increase a computation speed of the inverse image sampling process executed on an arbitrary modulus. Further, all of the algorithms may be executed by calling a static discrete Gaussian distribution. In addition, the above design also reduces a length of a public key.

Note that the lattice factor generation device 100 and the inverse image sampling device 200 of the present exemplary embodiment may be realized by a processor such as, for example, a central processing unit (CPU) that executes processing in accordance with a program stored in a non-transitory storage medium, or by a data processing device. That is, the lattice factor generation means 110, the lattice factor sampling means 210₁ to 210ₗ, and the sample value integration means 220 may be realized by, for example, a CPU that executes processing in accordance with program control.

In addition, each unit in the lattice factor generation device 100 and each unit in the inverse image sampling device 200 of the present exemplary embodiment may be realized by a hardware circuit. As an example, the lattice factor generation means 110, the lattice factor sampling means 210₁ to 210ₗ, and the sample value integration means 220 are each implemented by a large scale integration (LSI). In addition, they may be realized by one LSI.

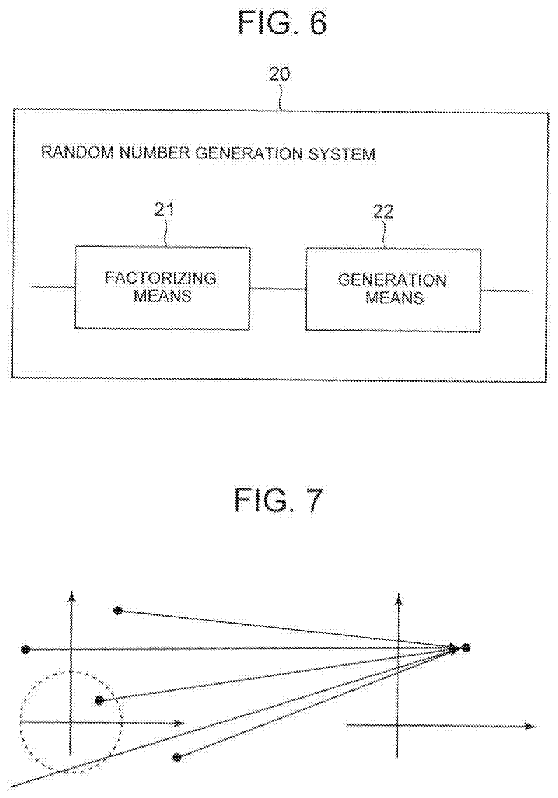

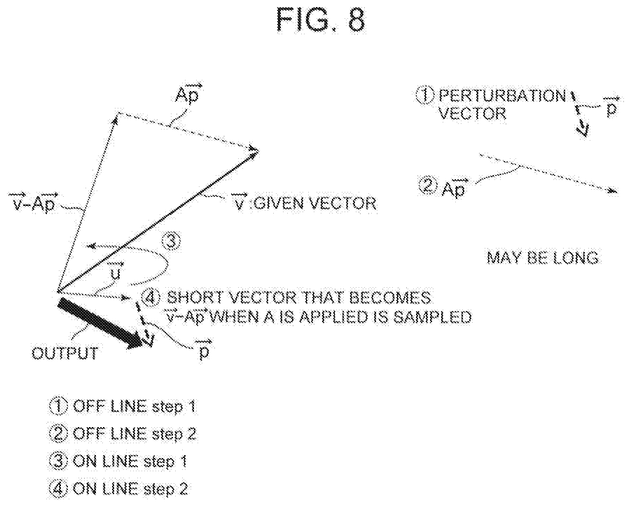

Next, an outline of the present invention will be described. FIG. 6 is a block diagram showing an outline of a random number generation system according to the present invention. A random number generation system 20 according to the present invention is a random number generation system for generating a random number using a public key, a component of which is the member of a residue class ring modulo of a predetermined natural number excluding natural numbers represented by the power of a prime in composite numbers. The random number generation system 20 includes: a factorizing means 21 (for example, the lattice factor generation means 110) that computes the prime factorization for a predetermined natural number; and a generation means 22 (for example, the lattice factor sampling means 210₁ to 210ₗ) that generates a random number in accordance with a discrete Gaussian distribution over a lattice wherein a vector having non-zero components of a single prime factor obtained by computing prime factorization and −1 is a basis vector.

Such a configuration allows the random number generation system to increase a computation speed of the inverse image sampling process executed on an arbitrary modulus.

Further, the generation means 22 may generate a random number by a cumulative method.

Such a configuration allows the random number generation system to further increase a computation speed of the inverse image sampling process.

Further, the generation means 22 may generate in parallel a random number over each lattice for each of multiple prime factors obtained by computing prime factorization.

Such a configuration allows the random number generation system to further increase a computation speed of the inverse image sampling process.

Further, the random number generation system 20 may include an output means (for example, the sample value integration means 220) that outputs data in which generated random numbers over each lattice are arranged side by side.

Such a configuration allows the random number generation system to output generated random numbers as random numbers in accordance with a discrete Gaussian distribution over an original lattice.

The present invention is considered to be used in the field of cryptography.

Although the present invention has been described with reference to the exemplary embodiment and examples, the present invention is not limited to the above exemplary embodiment and examples. Various changes that can be understood by those skilled in the art can be made to the configuration and details of the present invention within the scope of the present invention.

### REFERENCE SIGNS LIST

10 Inverse image sampling system
20 Random number generation system
21 Factorizing means
22 Generation means
100 Lattice factor generation device
110 Lattice factor generation means
200 Inverse image sampling device
211₁ Random number generation means
212₁ Center computation means
210₁ to 210ₗ Lattice factor sampling means
220 Sample value integration means

1. A random number generation system for generating a random number using a public key, a component of which is the member of a residue class ring modulo of a predetermined natural number excluding natural numbers represented by the power of a prime in composite numbers, the random number generation system including:
a factorizing unit, implemented by a hardware including one or more processors, which computes the prime factorization for a predetermined natural number; and
a generation unit, implemented by the hardware, which generates a random number in accordance with a discrete Gaussian distribution over a lattice wherein a vector having non-zero components of a single prime factor obtained by computing prime factorization and −1 is a basis vector.

2. The random number generation system according to claim 1, wherein
the generation unit generates a random number by a cumulative method.

3. The random number generation system according to claim 1, wherein
the generation unit generates in parallel a random number over each lattice for each of multiple prime factors obtained by computing prime factorization.

4. The random number generation system according to claim 3, further comprising
an output unit, implemented by the hardware, which outputs data in which generated random numbers over each lattice are arranged side by side.

5. A computer-implemented method for generating a random number executed in a random number generation system for generating a random number using a public key, a component of which is the member of a residue class ring modulo of a predetermined natural number excluding natural numbers represented by the power of a prime in composite numbers, the method comprising:
computing the prime factorization for a predetermined natural number; and
generating a random number in accordance with a discrete Gaussian distribution over a lattice wherein a vector having non-zero components of a single prime factor obtained by computing prime factorization and −1 is a basis vector.

6. The computer-implemented method for generating a random number according to claim 5, wherein
a random number is generated by a cumulative method.

7. The computer-implemented method for generating a random number according to claim 5, wherein
a random number over each lattice is generated in parallel for each of multiple prime factors obtained by computing prime factorization.

8. A non-transitory computer-readable capturing medium having captured therein a random number generation program for causing a computer to execute:
a factorizing process of computing the prime factorization for a predetermined natural number in a random number generated with use of a public key, a component of which is the member of a residue class ring modulo of a predetermined natural number excluding natural numbers represented by the power of a prime in composite numbers; and
a generation process of generating a random number in accordance with a discrete Gaussian distribution over a lattice wherein a vector having non-zero components of a single prime factor obtained by computing prime factorization and −1 is a basis vector.

9. The non-transitory computer-readable capturing medium according to claim 8, wherein
the computer is caused to
generate a random number by a cumulative method, in the generation process.

10. The non-transitory computer-readable capturing medium according to claim 8, wherein
the computer is caused to
generate in parallel a random number over each lattice for each of multiple prime factors obtained by computing prime factorization, in the generation process.

11. The random number generation system according to claim 2, wherein
the generation unit generates in parallel a random number over each lattice for each of multiple prime factors obtained by computing prime factorization.

12. The random number generation system according to claim 11, further comprising
an output unit, implemented by the hardware, which outputs data in which generated random numbers over each lattice are arranged side by side.

13. The computer-implemented method for generating a random number according to claim 6, wherein
a random number over each lattice is generated in parallel for each of multiple prime factors obtained by computing prime factorization.

14. The non-transitory computer-readable capturing medium according to claim 9, wherein
the computer is caused to
generate in parallel a random number over each lattice for each of multiple prime factors obtained by computing prime factorization, in the generation process.
